(19) United States
(12) Patent Application Publication
(10) Pub. No.: US 2009/0049542 A1
(43) Pub. Date: Feb. 19, 2009

(54) METHOD OF SOFTWARE DISTRIBUTION VIA THE INTERNET

(76) Inventors: James Joseph DeYonker, Princeton, NJ (US); William Douglas Hare, Princeton, NJ (US)

Correspondence Address: WILLIAM D. HARE, 66 WITHERSPOON STREET, STE. 1, PMB 317, PRINCETON, NJ, 08542-9944, US

(21) Appl. No.: 11/577,335

(22) PCT Filed: Sep. 22, 2006
(86) PCT No.: PCT/IB06/53462

§ 371 Date: Apr. 16, 2007

Related U.S. Application Data
(60) Provisional application No. 60/596,433, filed on Sep. 22, 2005.
(60) Provisional application No. 60/744,838, filed on Apr. 13, 2006.

(51) Int. Cl. H04L 9/32; A63F 9/24

(52) U.S. Cl. 726/18; 463/7

(57) ABSTRACT

In one general aspect there is provided a method for distributing software. The method comprising (a) a software user creating a user profile which includes one or more types of biometric data; (b) providing the biometric data to a software distributor; (c) obtaining the software; and (d) utilizing the software on the user's computer having a biometric sensing device that senses or measures a biometric parameter of the user useful for creating biometric data, wherein utilizing the software causes the activation of a verification program or function that compares the sensed or measured biometric data to the biometric data in the user profile. In another aspect, the invention relates to a method of handicapping two or more players of a game of skill, wherein the players are of varying skill levels. Also provided are methods of ranking players according to skill level and generating a professional gaming league based on skill level. Also provided is a system and an apparatus for verifying the identity of a user in a game of skill.

### TECHNICAL FIELD OF THE INVENTION

The present invention relates to a secure method of distributing software via the internet. Also provided is a method of verifying the identity of a user of software and an apparatus for verifying the identity of a user in a game of skill.

### BACKGROUND OF THE INVENTION

The software industry has resisted the acceptance and utilization of a system of digital distribution of software for fear of increased file sharing and pirating. The software industry has instead utilized site licenses, sometimes referred to as “user licenses” to distribute software to users. This method generally requires at a minimum the use of a sales force and a physical distribution network, which increases the costs of the software to the consumer and decreases the profit margin for the manufacturer.

In the global economy, small business are often times priced out of utilizing critical software due to the increased costs associated with the distribution of the software. This is particularly true in areas such as web development, graphic design and desktop publishing. In addition, software manufacturers are limited to distribution of full featured versions of their product, which in many cases are full of features that are of no use to small businesses. The lack of a more cost effective distribution system has produced a gap in affordable software for startups and small businesses, as well as a loss of revenue for software manufacturers. Moreover, potential users are not willing to pay for features which they do not utilize on a daily basis.

Nonetheless, in spite of these inefficiencies and unmet needs, the market for software continues to grow and this growth will be fueled by the emergence of broadband Internet connections worldwide and this growth increases the logic of utilizing a digital distribution method for software programs. Recent figures indicate that by the year 2008, nearly 80% of American households will have some type of high-speed Internet connection. Currently, approximately 50% of users go online via cable broadband, whereas 25% of users go online via DSL—and future trends allude to a higher percentage of users utilizing increased speed connections. Broadband connections are already extremely prominent in Asia. We expect to see a similar pattern in the United States and Europe.

Within the software industry, the online gaming segment is similarly growing. Between 2002 and 2007 the online gaming industry is expected to grow by about 30% to 50%, with revenues swelling to almost $30 billion. This growth will not be restricted to the United States, with Europe and Asia generally considered to have the greatest potential. By 2008 over 198 million gamers worldwide will be playing games online, divided equally between North America, Europe, and Asia. Total hours spent playing games online could top an astonishing 35 billion hours.

In what was started by online casinos utilizing games of chance, the internet gambling industry has recently exploded into a new direction featuring games of skill. Many of the game players today compete online via a communication network such as the World Wide Web. Players are utilizing their personal computers, mobile phones, and console based video game systems to connect with competitors all over the world.

Out of all gaming feature sets, competitive match play is the most important. Instead of game outcomes being based on random number generators, players now have the ability to control their future. Games of skill provide an outlet for players to compete and showcase their skill level to a world wide audience. In addition, games of chance for money are often times regulated or prohibited by governmental bodies. In these countries, collecting payments and/or awarding prizes to players based purely on game results which were generated in a random manner is illegal and would subject the proprietor to criminal penalties. Conversely, the result obtained in a game of skill is purely based on a player's performance. In these types of games, the player inputs certain parameters that directly correlate to the outcome of the game, and ultimately determine the awarding of prizes (i.e. a monetary payout).

However, games of skill present a whole new set of problems to both the provider of the game and the end user. For example, players must be able to assess the skill level of potential competitors in order to determine whether to a) engage in the game with the competitor, b) bet money on the game and c) whether the risk is worth the reward. Fairness must be achieved between players of different skill levels in order for beginner users to return to the game even after a defeat and continue to wager money on their skill. In addition, the game server must be able to maintain the integrity of the system, but also must be able to verify that the person competing in the game of skill is the person whose game profile is active.

U.S. Pat. No. 6,468,155 discloses a method to facilitate games of skill for prizes played via a communication network. According to one embodiment, a potential game to be played at a remote player device via a communication network is determined. The potential game is evaluated to estimate an amount of player skill required to play the potential game, the evaluation being performed based on a sample of player performance information. The potential game is modified if (i) the amount of player skill required is unacceptable or (ii) the ability of the automated game playing device is unacceptable.

U.S. Pat. No. 5,813,913 discloses a game of skill played simultaneously whereby each participate player effectively competes only against players having a similar skill level in order to provide a strong motivation. The system includes a central computer system with each remote participant having a control unit. The control unit either stores or has supplied to it the particular skill level of the player and at the end of the game, only the relative scores at that particular skill level are indicated to that player. The system also provides for effective promotion or updating to a higher skill level of successful players of the game.

U.S. Pat. No. 6,224,486 discloses a method and a system for a distributed electronic tournament system in which many remotely located players participate in a tournament through input/output devices connected to a central controller which manages the tournament.

U.S. Patent Application No. 20040242299 discloses systems and methods to facilitate games of skill for prizes played via a communication network. According to one embodiment, a fee is received from a player in exchange for game play. During game play, a game controller receives a player input parameter from a remote player device. A game result is then determined based on the player input parameter and a value, the value being generated at the game controller without being communicated to the remote player device prior to the determination of the game result. A prize may then be awarded to the player based on the game result.

U.S. Pat. No. 5,779,549 discloses a method and a system for a distributed electronic tournament system in which many remotely located players participate in a tournament through input/output devices connected to a central controller which manages the tournament. The method includes the steps of (a) uniquely identifying a player communicating with the central controller via an associated input/output device; (b) responding to payment of an entry fee by the player for allowing the player to participate in a tournament occurring within a fixed time window via an associated input/output device; (c) accessing a database to store in the database player information that is generated as the player participates in the tournament, such information being available for use in a subsequent tournament, which is administered by said controller and in which the player participates; and (d) awarding the player a prize for achieving a pre-established performance level in the tournament. In another preferred embodiment, the method further includes the steps of determining whether the player has been qualified to advance to a subsequent game session, in which at least one player is eliminated from the previous game session; and permitting each player qualified to a subsequent game session to participate in that game session. The system includes software and hardware to implement the method steps.

U.S. Patent Application No 20040132521 discloses a method of determining a most skilled individual from a group of individuals in a tournament setting over a computer network. A method of determining skill level in a card game in a tournament setting comprises assigning players to a plurality of tables, each table consisting of a predetermined number of labeled positions. Cards are provided to each player over the network such that players seated at positions with the same label at each table have the same cards. The performance of players at the same position at different tables is compared after playing a game and such players are ranked as a measure of their skill level.

U.S. Patent Application No. 20030040363 discloses an Internet/network game site is provided whereby site-users may spend digital tickets in order to compete in site-games having a prize that is awarded to the game winner. Site-visitors may become site-users by submitting user-identification that includes a credit card method of payment for the purchase of digital tickets. A site-user may thereafter purchase digital tickets after supplying site-user-identification, whereupon purchased digital tickets are recorded for the site-user, and whereupon purchased digital tickets are paid for using the specified credit card method. A plurality of site-games are provided to be played by site-users. A merchant may contribute a product/service having a stated monetary value as a prize for a game. The Internet site automatically increases this stated monetary value to a higher monetary value, assigns the prize to the game, and that assigns a number of digital tickets to the game so that a total monetary value of the digital tickets assigned to the game equals the higher monetary value. When a site-user elects to participate in the game, the site-user is charged a digital ticket monetary amount that is based upon the higher monetary value of the prize assigned to the game, and the purchased digital ticket quantity recorded for the site-user is accordingly reduced. The site monitors a number of digital tickets used to compete in the game, and terminates the game when a total monetary value of digital tickets used to compete in the game equals the total monetary value of digital tickets assigned to the game. A winner of the terminated game is determined, the prize is delivered from the merchant to the winner, and the merchant is paid a monetary value that is greater than the stated monetary value, but is less than the total monetary value of digital tickets assigned to the terminated game.

U.S. Patent Application No. 20030027639 discloses a method and apparatus for playing a game of skill in a networked environment. A host server transmits a game data packet to each participant after receiving a request from the participant. Upon initiation of game play, the participants are shown identical game messages so that each participant is playing the same game. After a participant believes they have won the game, a message is sent to the server. The server then evaluates the performance of all the participants and determines a skill level for each participant.

U.S. Patent Application No. 20020037767 discloses methods operable through a distributed computer network are disclosed which enable direct game play against remotely situated players, of the same skill, and with payout rules of their choosing. One method enables players to gamble directly with one another. In this method, a host server receives a bet from a machine operated by each player, with each machine being connected to the host server through a distributed network. The received bets are combined into a pot, and a hosted game commences among the set of players that contributed to the pot, by prompting the players at their respective machines for inputs. Inputs are then received at the host server and at least one winner is selected from among the set of players on the basis of the received inputs. The pot is then allocated to the at least one winner in accordance with prescribed rules. Another method enables teams of players to compete directly against each other for money. That method includes the steps of establishing several teams across a distributed network, receiving an ante conveyed from each player's machine and combining the antes from all of the players into a pot. A hosted game is then commenced among the teams by prompting the players of each team at their respective machines for inputs. Inputs are thereafter received at the host server, and at least one winning team is selected from among the teams based on the received inputs. The pot is then allocated to the at least one winning team in accordance with prescribed rules.

U.S. Patent Application No. 20020004424 discloses a method, apparatus, and system for an electronic game of skill, wherein multiple remotely located players can compete for a common prize. In preferred embodiments, a user accesses the game via a wide area network or by some other remote means and inputs required information, including payment information. Preferably, the player then authorizes the payment of the entry fee and competes in a contest of skill, preferably a trivia game, where a prize or prizes are awarded to players that reach a predetermined performance level. Preferred embodiments of the present invention include, without limitation, multi-tiered, pari-mutuel and progressive prize pay-out methods.

U.S. Pat. No. 5,816,918 discloses a prize redemption system for use with one or more game apparatuses. A game is provided on a game apparatus for a player to play in exchange for monetary input, and prize credits are credited to the player based on the game outcome. A prize selection menu is then displayed by the game apparatus, the menu including one or more prizes, where the player may select a prize that has a prize cost within the player's prize credit amount. The player is dispensed a specific prize ticket that is redeemable for the selected prize. The game apparatus can also provide specific prizes and tournament games played for a tournament prize contributed to by multiple players. An operator can adjust prizes and payout percentages of the system to achieve a desired profitability for game apparatuses. Prize input is entered into a prize table describing multiple available prizes and also describing payout information that indicates a desired amount of payout that the operator wishes to provide back to players of the game apparatus in terms of the value of the prizes. Prize information, such as prize costs and specific prize win ratios, is automatically determined by the system for each of the prizes in view of the desired profitability of the game apparatus.

U.S. Pat. No. 6,709,333 discloses a system and method for using two authenticators to identify a player in a gaming environment is disclosed, where the second authenticator is based on biometric data. The two authenticators allow a two-level authorization process providing very high assurance that a player at a gaming machine is who they claim to be, and where the second authenticator, being based on biometric data, enables a player to quickly and easily authenticate documents and/or authenticate age while continuing to play at game machines.

There are presently no methods of balancing fairness on games of skill played by two or more players over a communication network or to verify that the players competing are the players whose game profile was selected as a competitor. When two players are not physically located with their competitors, a method must be implemented to calculate an individuals' skill level and assign a comparative skill level quotient based on the total global skill level average. Further, a system is needed to verify that the user having a specific skill level quotient and skill class level is in fact the person playing the game of skill start to finish. By understanding and trusting a competitor's skill level as an accurate depiction, player's can confidently place a monetary wager on his/her positive outcome in a game of skill. Additionally, by providing a fair and accurate global ranking system, the top players may be designated as professionals and therefore qualify for participation an advanced, and more lucrative, competitive environment.

### SUMMARY OF THE INVENTION

In one general aspect there is provided a method for distributing software. The method comprising (a) a software user creating a user profile which includes one or more types of biometric data; (b) providing the biometric data to a software distributor; (c) obtaining the software; and (d) utilizing the software on the user's computer having a biometric sensing device that senses or measures a biometric parameter of the user useful for creating biometric data, wherein utilizing the software causes the activation of a verification program or function that compares the sensed or measured biometric data to the biometric data in the user profile.

Embodiments of the method may include one or more of the following features. For example, the sensing or measuring may be performed on a random basis. The sensing or measuring may be performed on a random and continuous basis. The verification program may include an algorithm that sets a rate of verification.

The verification program may include a frequency of scanning of the biometric parameter. The frequency of scanning may be varied based on one or more previous measurements of the biometric parameter and the verification of the correct user or incorrect user. A verification of an authorized user may result in a decrease in the scanning frequency. A verification of an unauthorized user may result in an increase in the scanning frequency.

The biometric sensing or measuring device may be an input device capable of scanning biometrics of the user. The input device may be a computer mouse having fingerprint scanning capabilities.

The software may lock out the user if the comparison of the sensed or measured biometric data to the biometric data in the user profile indicates the user is not authorized to use the software.

The user may provide the user biometric data and/or obtain the software by connecting the distribution site by connecting via the internet. Providing the biometric data may further include providing a user profile comprising one or more types of personal information of the user. The biometric data may be incorporated directly or indirectly into the software program being obtained by the user. The biometric data may be stored on a central server and/or a local computer.

In the method, obtaining the software may include downloading the software over the internet. The user may use the software on any computer having the software by using an input device that allows for the comparison of the user's biometric data to the biometric data obtained for the user's profile.

In another general aspect there is provided an apparatus and method for verifying the identity of a player competing in a game of skill over the internet, the apparatus comprising an input controller comprising at least one biometric sensor, wherein the biometric sensor scans continuously or semi-continuously and randomly throughout game play and verifies that the biometric scan matches a biometric scan which is associated with the player, at least one directional controller, one or more input buttons and at least one means for connecting to a computer based device.

In one other general aspect there is provided a method for handicapping players of different skill levels in a game of skill, wherein the players' skill level is determined from a subset of statistical categories, the players are designated into a skill class level and a set of odds between the competitors is generated and used to determine the monetary payout after a result is achieved.

Embodiments of the present invention may include one or more of the following features. For example, the number of skill class levels may be increased or decreased based on the total number of players ranked for a particular game of skill. The global rankings for a particular game of skill may be updated in a real time fashion to ensure complete disclosure of a player's history.

In another general aspect there is provided a method of creating a professional gaming league. The method includes handicapping players of different skill levels in a game of skill, wherein the players' skill level is determined from a subset of statistical categories, and the players are designated into a skill class level. By obtaining a minimum skill class level for a predetermined period of time, a player may be designated a professional for the particular game of skill he competed in.

Embodiments of the present invention may include one or more of the following features. For example, by obtaining the designation of professional, a gamer may able to wager more money of the outcomes of a game of skill and he may use sponsorship and advertisements while playing in the game of skill to raise additional revenue.

In another general aspect there is provided an apparatus which includes a means for connecting to the central game server, means for computer date, a means for the storage of data, and a means for connecting to a video display. The apparatus would connect to the central game server and would update a player's global ranking and statistics in real time based on the method of handicapping and ranking players' of different skill levels.

In another general aspect there is provided a system for verifying the identity of a player competing in a game of skill over the internet. The system enabling individual player identification is usable in a gaming environment. The system includes a user created game profile comprising biometric data, a means for entering a continuous and undetectable authentication into said system, wherein the authentication is in the form of biometric data, a means for verifying that the biometric data scanned continuously and randomly during game play matches the biometric data maintained in the user's game profile.

Embodiments of the system may include one or more of the following features. For example, the system may only require the continuously and randomly scanned authentication to match the game profile biometric data at least 50% of the times during game play or the system may only require the continuously and randomly scanned authentication to match the game profile biometric data at least 20% of the times during game play.

In another general aspect there is provided an apparatus for verifying the identity of a player competing in a game of skill over the internet. The apparatus may in the form of an input controller comprising at least one biometric sensor, wherein the biometric sensor scans continuously and randomly throughout game play, at least one joystick or directional controller, one or more input buttons and at least one means for connecting to a computer device.

Embodiments of the apparatus may include one or more of the following features. For example, the apparatus may further include a means for scanning a credit card, one or more means for scanning memory cards, and one or more displays.

In another general aspect there is provided a method creating a professional gaming league, wherein the game player's identification is scanned and verified throughout the game of skill. The method includes creating a user game profile that includes biometric data, continuously and randomly authenticating the player into said system, wherein the authentication is in the form of biometric data, a means for verifying that the biometric data scanned continuously and randomly during game play matches the biometric data maintained in the user's game profile, recording the outcome of the game of skill and updating player's game profile, determining the players' skill level quotient from a subset of statistical categories, designating the player into a skill class level and a determining if the player's skill class level is sufficient to be deemed professional; wherein the professional designation is awarded to the top skill class level.

### DETAILED DESCRIPTION OF THE FIGURES

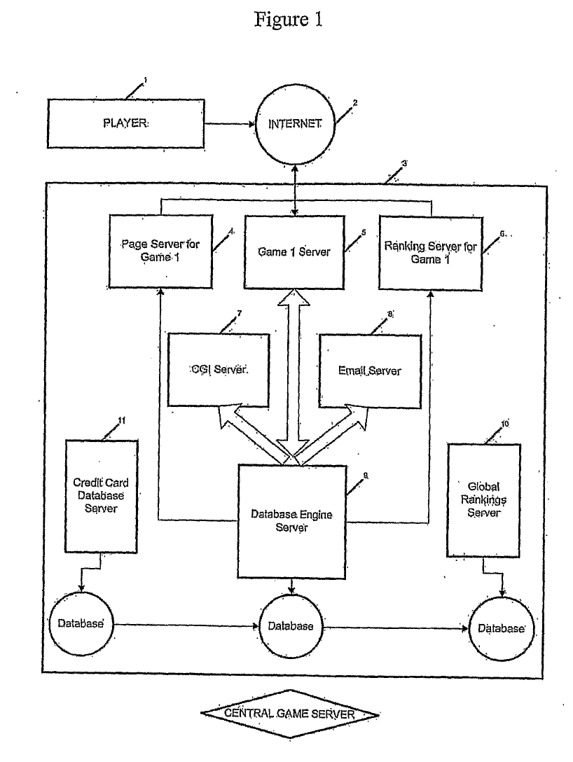

FIG. 1 depicts a general schematic of the Central Game Server.

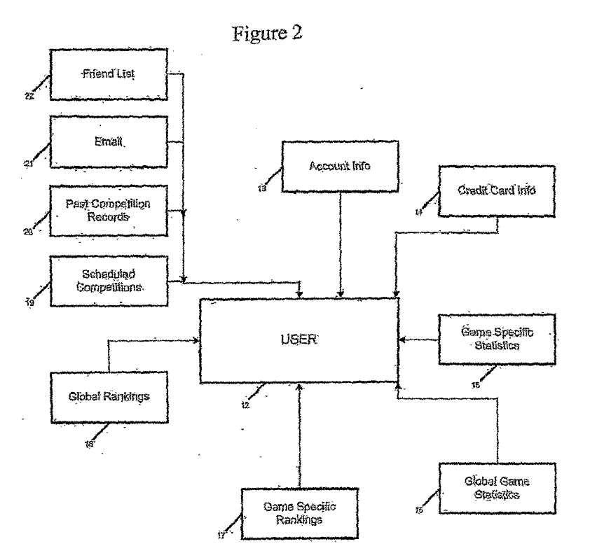

FIG. 2 depicts a general schematic of the User options when connected to the Central Game server.

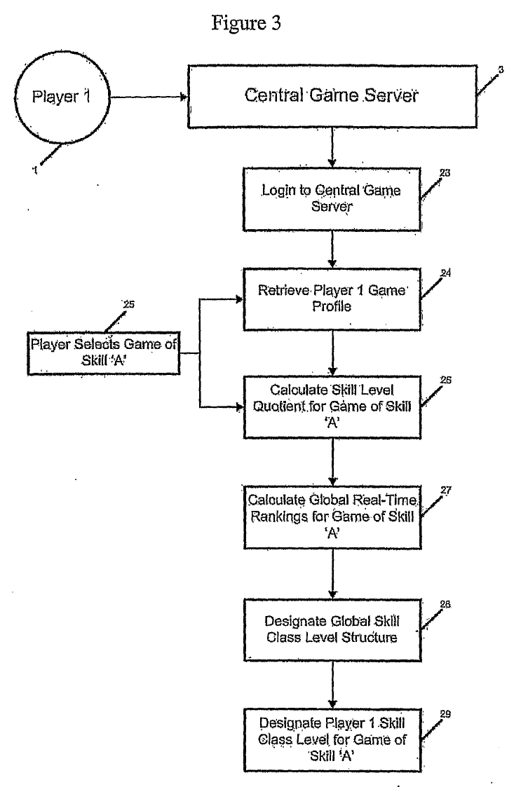

FIG. 3 depicts a method of determining the Skill Quotient and Skill Class level for a Player.

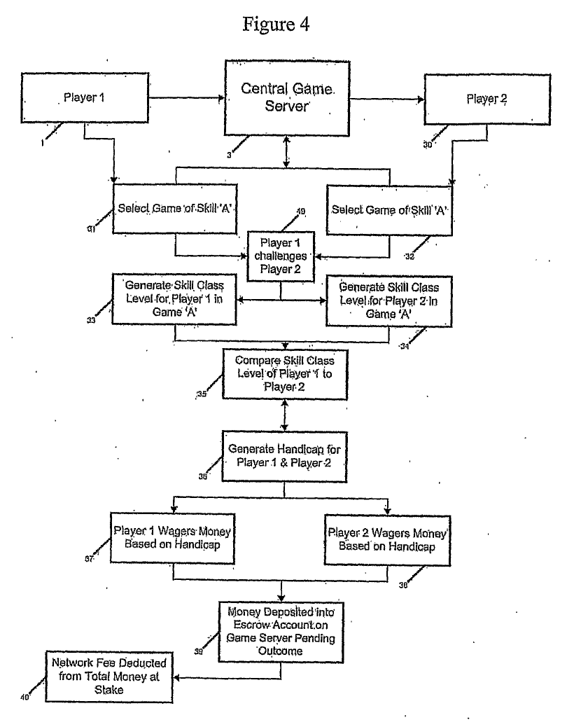

FIG. 4 depicts a general schematic of a method of generating a handicap between two players of different skill quotients and skill class levels.

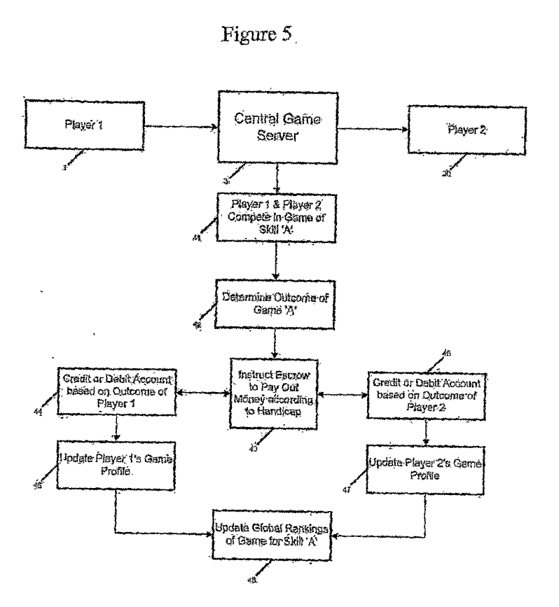

FIG. 5 depicts a general schematic of a method by which the Central Game Server pays out money based on a pre determined handicap.

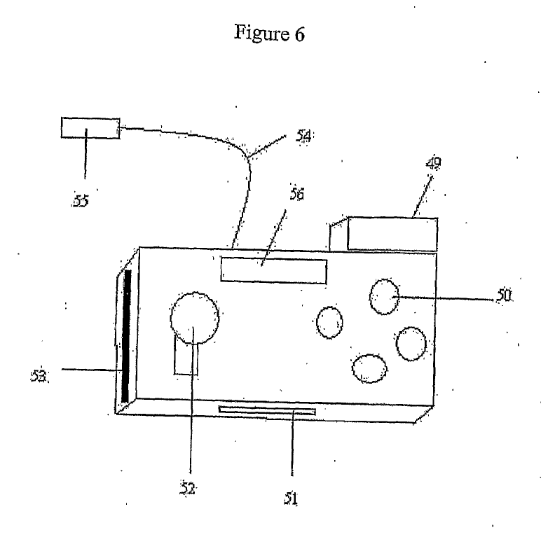

FIG. 6 depicts an input device which continuously and randomly authenticates the user.

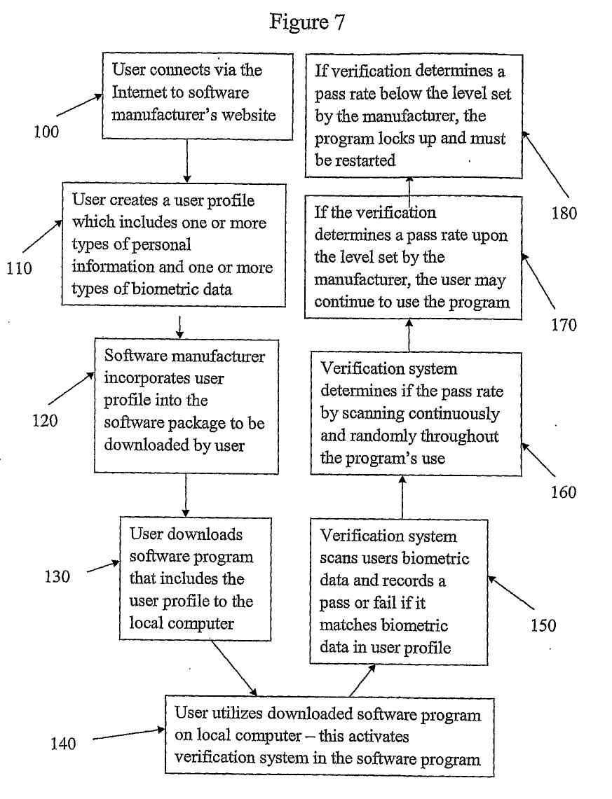

FIG. 7 depicts a general schematic of a method to digitally distribute software programs.

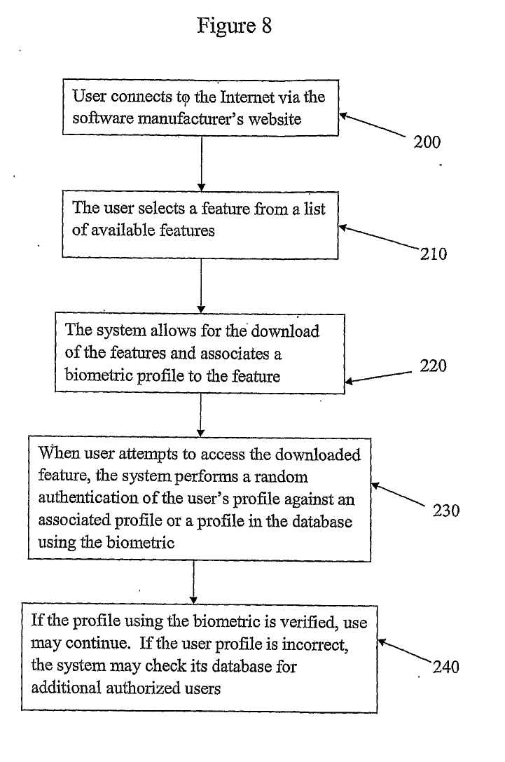

FIG. 8 depicts a general schematic of a method to digitally distribute limited use software and digitally upgrade such software.

### DETAILED DESCRIPTION OF THE INVENTION

The present inventors have now found a method of digitally distributing software programs via the internet. Referring generally to FIG. 7, the method includes the user connecting via the internet to a software manufacturer's website or other authorized distribution webpage (step 100) and the user creating a user profile which includes one or more types of personal information and one or more types of biometric data scanned from an input device (step 110). Once the user profile is completed, the data is transmitted to the software manufacturer's database located on a central server. The user's profile, which includes the biometric data, is incorporated directly or indirectly into the software program being downloaded (step 120) and the software then is downloaded (step 130). When the user attempts to utilize the program on their local computer, the software will activate a verification program or function (step 140). The verification program includes an algorithm that sets a rate of verification. The user must use the software program with an input device capable of scanning biometrics of the user. As the user utilizes the downloaded software, the algorithm will randomly and/or randomly and continuously scan to verify that the user of the software is the user who registered for its use when it is initially downloaded (steps 150 and 160). The algorithm sets a frequency of scanning to the desired level of the software manufacturer. So long as the biometric data scanned matches the profile at a frequency above the approved limit, the user can continue to use the software (step 170). If the biometric scan pass rate is less than then approval limit set by the software manufacturer, the software locks up and can no longer be used until other conditions are met, as may be determined by the software manufacturer (step 180).

As described in additional detail in the present application, in some implementations there may be little difference between randomly scanning a biometric identifier and randomly and continuously scanning a biometric identifier. Generally, the two terms are used interchangeably to indicate that the biometric variable may be scanned at anytime, not just upon initial use, and the random scanning may occur throughout the use of the software. Thus a random scan may be a single scan that occurs at any one or more times during use whereas randomly and continuously scanning may be multiple scans that occur at various random times during the use. In general, a single scan at initial use of the software, upon every use of the software, is not considered to be random or random and continuously.

Referring to FIG. 8, the software manufacturer may also use the verification method to distribute bare bones (limited feature) software programs and later obtain upgrades to the features as and if desired by the user. The user can digitally download a feature restricted version of a software program. This method includes creating a user profile that includes one or more types of personal information, one or more types of biometric data, and a feature set which the user wishes to activate. Once the user profile is completed, the data is transmitted to the software manufacturer's database located on a central server. The user's profile, which includes the biometric data and the feature set activated (or purchased), is incorporated into bare bones (limited use) software program being downloaded.

When the user attempts to utilize the program and the features that are activated on their local computer, the software will activate a verification program. The verification program includes an algorithm that sets a rate of verification. The user must use the software program with an input device capable of scanning biometric data of the user. As the user utilizes the downloaded software, the algorithm will randomly and/or randomly and continuously scan using the input device to verify that the user of the software is the user who registered for its use (and the features which were activated) when it was initially downloaded. The algorithm sets a frequency of scanning to the desired level of the software manufacturer. So long as the biometric data scan matches the profile at a frequency above the approved limit, the user can continue to use the software and the activated features. If the biometric data pass rate is less than then the approval limit set by the software manufacturer, the software locks up and can no longer be used.

Referring still to FIG. 8, should the user want to activate new features, the user may sign onto the software manufactures website (step 200) and select additional features to purchase (step 210). The user submits an updated profile, which includes an updated set of features for which the user wishes to purchase. This user then downloads a supplemental activation program which updates the local copy of the downloaded software to activate the bare bones (limit use) software to include the new features (step 220). When the user utilizes the originally downloaded program that includes the supplemental activation program, the algorithm will randomly and/or randomly and continuously scan the user's biometric data using the input device to verify that the user of the software is the user who registered for its use (and the features which were activated) (step 230). If the user is not an authorized user or the authorized user, the use may continue and the system may check a database of authorized users to determine if the user is authorized (step 240).

Suitable connection devices to connect to the manufacturers' website include one or more of a personal computer, a dedicated video game console, a cellular communication device, for example, an analog or digital cellular phone, PDA, Blackberry® device, smart phone or similar devices, and any other device capable of connecting to the central server.

When the user operates the input device, the user must generally maintain contact with the biometric sensor, although it is understood and may be taken into consideration that users do not necessarily maintain constant contact with the biometric sensor during the entire period of use. Thus, the system will use an algorithm that takes into account that reality. For example, if the biometric sensor performs a scan that provides data indicative of no user holding the biometric sensor, it may be configured to not include that data as indicative of user identity. Of course, because unauthorized users may then try to game the system by holding the biometric sensor in a particular manner, the algorithm can be configured to compare whether a scan was made in which there is no data to indicate a user at all and during the same period the software was in use, e.g., the cursor is moving or some other indicator of user activity. If this contradiction occurs then the algorithm may make the conclusion that a user is attempting to avoid the biometric sensor and a subsequent action may be taken. For example, in one implementation, a pop up window may appear that instructs the user to place his/her thumb over the biometric sensor to allow a scan to be made. The biometric sensor may be a fingerprint scanner, a bioimpedence sensor or any other sensor which is capable of verifying the identity of the user.

Biometric identification systems such as fingerprint readers built by AuthenTec, Inc., in Melbourne, Fla. 32902, are known. These readers may supply raw image data to a processing unit for storage and analysis, or as is typically the case with commercial products, will record and transmit fingerprint characterization data, not an image. In the later case, the fingerprint itself (an actual image) will not be permanently stored; only a numeric characterization is kept.

Prior art numeric characterization of fingerprints makes use of a fingerprint's ridges and furrows on the surface of the finger. The uniqueness of a fingerprint can be determined by establishing a center or reference point, and characterizing the pattern of ridges, furrows, and/or other characteristics such as ridge bifurcation and/or a ridge ending points (sometimes called minutiae points) in relationship to the center point.

There are well known limitations when using fingerprint characterization data. The faster a fingerprint is read, the fewer details may be recorded (for example, establishing 40 correlation points rather than 80). In addition, the ability to read fingerprints themselves will vary depending on the condition of the skin on the finger, sweat, dirt, etc. Thus, it may be the case that a fingerprint read having 80 correlation points may produce, in a large database (over 100,000 entries), more than one match. That does not mean that the actual fingerprints are the same; rather, it means that the recorded characteristics appear to match more than one entry. This is typically not an issue in small populations or when using a small database, but will arise on occasion. For the present invention, in one implementation, the fingerprint will only be compared to the user profile that includes the original “ID Print”. This will verify that the user playing the game of skill or using the software is the same start to finish. The ID Print is the standard print that is associated with a specific game or user profile. This ID Print will be established when the user first registers to compete in games of skill or otherwise downloads the software.

It should be noted, however, that in one implementation, the system allows an authorized user of software to access the software on any computer in which the software has been downloaded. In this implementation, the user has already purchased the software and is a valid user of the software. If, for example, the user travels to a different office within his/her company, they may wish to use the software at that site on some other employees computer. By accessing the software and having a biometric scan performed, the biometric data can be initially compared to the local profile on the computer, namely, that of the last user of users. If there is no match, the algorithm in this implementation is configured to check against the database at the manufacturer's server. In this manner, a match will be found if the user is permitted to use the software and that biometric data then will be stored on that computer and become, for example, one more biometric data that is part of the local profile. In this manner, users can travel between various locations within the company, or even between home and the office, and have the ability to use the software.

There are public and proprietary algorithms that attempt to use the data to minimize false positives and maximize correct rejections. The characterization data is stored in a database where it can be searched for matches. The database may be located locally on the input device, the client side computing device, and even the manufacturer's server. It is also anticipated that companies can be created that will server as server-based databases for this type of information and system and will be contracted out by the manufacturer and/or users.

Because of the difficulties in collecting, characterizing, storing, searching, and uniquely identifying fingerprint data (i.e., inexpensive readers may collect 40-50 characterizing points, which although reasonably good, may still only be unique to an approximate range of 1/10,000), fingerprints generally have not been usable as a single source of identification means in a dynamic gaming environment. Many of the issues faced by the gaming industry are not faced by other industries, which would allow the reasonable implementation of, as an example, an authentication system based on a single fingerprint for a home or office PC where there may be 1 to 10 authorized users. Such systems have tiny databases, can be relatively slow, and can be reasonably fallible (in terms of false positives) and yet meet the authentication needs of the few people and limited environment in which such a system will be used. Such systems are not suitable for situations as the gaming industry, which must meet the needs of both speed and a significantly higher degree of assurance in any particular authentication. Thus, there is a need to provide an alternative means for player authentication having reasonably high reliability and assurance, coupled with very high authentication speed.

The present invention may use any biometric reading, although those providing reasonably high degrees of uniqueness are clearly preferred. It is expected that at the present time, the predominant biometric used will be based on fingerprints. The biometric scanning and verification will continue throughout the game of skill. The biometric scanning and verification operates randomly, so that the user is unaware of when or how often the verification is taking place (namely, randomly and continuously as opposed to once and then shut off, which would not be continuous). This prevents the user from passing the input device to other user, which would destroy the integrity of the competition, as well as, the system as a whole.

A biometric sensor may include one or more of fingerprints, hand geometry scans, retinal scans, iris scans, facial feature scans, or other biologically-based measurement means. For example, the biometric sensor may be a fingerprint scanner or it may be a very high frequency, low energy electromagnetic emitters/reader, a scanner of some or one of the body's natural emissions using a passive or resonant reader.

Fingerprint data is used in a preferred embodiment of the present invention. The word “fingerprint” can be used, in the common vernacular, to mean both the image left when a fingertip is pressed onto material that will allow some type of imprint to be left, the image seen of the finger when viewed with a scanner, or body oils and skin that leave a distinguishable mark having a unique set of ridges, etc., as well as meaning the unique pattern on the fingertip itself, even if not transferred to another surface. To avoid confusion with nuances of the word “fingerprint” when used alone, and add as much clarity as possible, this disclosure will use the term “fingerprint data”. “Fingerprint data” is defined generally to mean at least some data, where the data is such that it is storable and useable by digital logic and/or digital computers, that is derived from a portion of a finger or fingertip, and that in some way measures, identifies, or characterizes some portion of the pattern of swirls, edges, separation points, etc., found on a portion of the fingertip being used for identification. Thus, it is clear that the term “fingerprint data” does not mean a complete set of data that will always uniquely identify a single finger from a single human. Rather, it is used to mean there exists a data set (a data set is more than one bit of digital data), usable in digital circuitry, having some data derived from at least a portion of a finger or fingertip where the fingertip is being used for identification purposes. This definition avoids the problem of having to constantly differentiate between the fingertip, the fingerprint on the fingertip, the fingerprint left after a fingertip is pressed to a surface, the exact method used to collect fingerprint information in a fingerprint reader, and the completeness of each reading of a fingerprint. “Fingerprint reader” means any method and device that may be used to yield “fingerprint data”.

In another general aspect, the identity verification system can be used in verifying that an authorized user of a software program is the user of that program. For example, if the program at issue is a video game, a business software tool/program (e.g., an Adobe Acrobat program, Microsoft Office, an anti-virus or firewall program, etc.), a personal use software tool/program (e.g., Tax Cut, Photoshop, etc.), or any other software, program, the identity verification program can be implemented to ensure that only licensees of the software are using that software. In particular, the identity verification program can operate to capture a finger print of the user's hand, or other biometric identifier, operating the mouse while running the licensed software. Therefore, the system can continuously or semi-continuously and randomly verify that the user of the program is a licensee.

This aspect has the possible advantage of permitting a software program to be purchased over the Internet, downloaded onto a computer via the Internet, and registered to an individual user—or in some aspects to multiple users. In one implementation, to register a user, the downloaded software having the identity verification program incorporated in it prompts or requests that the user: (1) place his/her hand on the mouse (or other biometric identifying device), (2) leave his/her hand on the mouse while the software runs a scan of the user's biometric identifier, and (3) remove his/her hand upon completion of the scan. Optionally, the identify verification program then can prompt the user to register additional licensees or users of the program in the same manner. For example, the software may be offered at different prices depending on how many users are licensed/authorized to use the software. The software vendor may allow licensees to use the software for short periods of time, for example one month or long term periods, for example, one or more years. The vendor may also allow pay per use subscriptions at an increased or different rate per hour or any interval of time that is relevant for the type of software being used.

Although the above implementation describes a system in which the user has his/her biometric identifier associated with the software upon purchase or at download, the program can be implemented to allow the user and additional users to register and/or have their biometric identifier associated with the software at a later time. In these implementations, the biometric identifier may be stored in at least two general locations: (a) on the computer in which the software is downloaded and/or (b) in a database owned, operated by or for, or otherwise under the control of the software owner/distributor. The use of the biometric identifier data stored at either of both of these locations provides a number of options for verifying user identify. In case the biometric data is stored in a database, for example, on a host computer, operated by the software owner/distributor, when the user opens and uses the software, there will be a request for verification by the host computer. This causes the mouse or other biometric sensing/measuring tool, to scan for the finger print or other biometric identifier and transmit it back to the host computer. At the host computer, the measured biometric identifier is compared to the stored biometric identifier. Depending upon how close the measured biometric data is to the stored biometric data, the host computer will send a response indicating authentication or verification or do nothing. However, if there is a difference between the measured and stored biometric data, and that difference is greater than a set threshold level of difference, the host computer may proceed according to a number of options.

As one option, the host computer may send a signal to the user's computer which causes the software to be locked. As another option, the host computer may send a signal to increase the frequency of the scan or alter the resolution of the scanning of the biometric identifier. The increase in frequency may be made using an algorithm that causes the scans to be random but nonetheless at a greater frequency than a comparable random generation of scans at a lower frequency. In this manner, the host computer can then compare scans of increasing or decreasing resolution against the stored scan, which can be in the form of numerous scan resolutions that generally correspond to resolutions that could be used in practice or a single scan that can be mathematically manipulated to provide simulated scans at various resolutions. One primary objective of varying the frequency of scanning (whether frequencies generated on a random or preset basis) and/or resolution of scanning include ensuring that a false negative (i.e., the user is actually the licensed user although the scan indicates otherwise) does not occur. As another option, the host computer can take the incidences of unlicensed user use and contact the licensed user (e.g., by an automated email messaging program) to verify that the user is the user currently using the program and/or provide a reiteration of the software license agreement and/or provide a warning about a possible locking of the program if unauthorized use continues. The message and/or warning to the user can be in the form of a pop-up or other message that will be seen by the user of the program during the potentially unauthorized use. Moreover, the biometric scans can be saved and used later as supporting evidence to prosecute unlicensed use is of the software and/or the licensed user allowing them to use the software in violation of the software license agreement.

These above implementations contemplate a communication between the host computer and the user's computer such that the scans can be transmitted from the user's computer via, for example, the Internet under a specified level of encryption, and then processed on the host computer to verify that a licensed user is operating or using the software.

In order to provide increased security, all data including fingerprint data, Host computer responses and user personal information, will be encrypted using any level of encryption technology available at the time of implementation. The software vendor or host database management can set the level of data encryption to each individual application. This level may vary depending on the nature and cost of the application being run. This helps maintain a user's privacy by encrypting personal information.

As an alternative that offers some advantages, the scanning data can be processed and the comparison made using the scan data stored on the user's computer, optionally as a duplicate of the scan data stored on the host computer. The warnings, messages, and determination to lock up the software then can be made from the downloaded software on the user's computer whether or not there is a communications link between the host computer and the user's computer.

Applicants believe that these particular aspects of the invention offer potential advantages to designers, manufacturers, and distributors of software because the need for the sale of software through brick and mortar stores is reduced. This reduction results because the illegal sharing of downloaded software can be reduced under the conditions described herein where only the authorized user or users will be permitted to continue the use of the downloaded software and sharing of the purchased software by copying will not provide anything more than an unusable program stored on an unauthorized user's computer. This implementation may offer an advantage to the software industry by allowing the unauthorized user to temporarily use the software enough to realize its value such that they choose to purchase the software before it locks them out. For example, upon detecting an unauthorized user the software may provide a certain amount of usage before notifying the unauthorized user that his/her unauthorized use has been detected and will be allowed to continue for a certain amount of time before the software will lock him/her out. Because that unlicensed user's biometric data will be ultimately transmitted to and stored on the host computer, the software company will be able to use an automated system to block unlicensed users no matter whose computer or whose downloaded software that unlicensed user is operating.

This system also reduced the cost of distributing software and allows the software industry to reduce its costs and therefore lower its selling prices, which ultimately provides accessibility options to consumers of software.

Further, as the use of broadband Internet connections has increased, this system can be implemented by allowing authorized/licensed users to access the software without downloading the software by instead accessing the software as it resides on a host computer. By registering as a licensed or authorized user through providing one's biometric data, an individual can use any computer with a biometric sensor and connect to a host computer upon which the software resides. So long as the user continues to meet the host computer's biometric correlation specification, use is permitted. Again, ensuring that the user continues to meet the host computer's biometric correlation specification can be implemented using a scanning that randomly occurs. In this system, the entire cost of the software distribution is almost completely eliminated, from manufacturing and encoding CDs with the software, to packaging and shipping the software-containing CDs, to building and storing inventory and dealing with returns.

This cost reduction, along with the reduced incidence of piracy, may advantageously offer cost savings to the software industry and the software consumer. Moreover, in any of the above implementations, the consumer advantageously no longer must deal with the issue of damaged or sub-functioning CDs that contain the software but have been damaged in use or where poorly manufactured initially. Rather than worrying about maintaining the condition of one's CD software collection, the user advantageously can use his/her biometric data to download a new copy of the software in the unlikely event that a new copy is needed, or connect to the Internet to the host computer to access the software there. This feature has the added benefit of allow users to update new computer systems or offices with the proper software simply by re-downloading the licensed software. Businesses can easily equip traveling employees with the necessary software irregardless of global location.

The inventors have also now found various methods of balancing players of different skill levels in a game of skill, wherein the players' skill level is determined from a subset of statistical categories and a set of odds between the competitors is generated and used to determine the monetary payout after a result is achieved. The method includes using a communication device as a means for a multitude of players to connect via the World Wide Web to a central game server. Once connected to the central game server, a player may login to load the game profile and select a game of skill to play. The game server acts as a means for retrieving and loading the players' game profile, wherein the game profile includes one or more statistical records which are appropriate for the particular game being played. The central game server calculates a skill level quotient by analyzing a player's game profile for the game of skill selected. This calculation may be made by any algorithm, which one skilled in the art would recognize would effectively generate a comparative skill quotient.

Players select a competitor and the game server compares the player's skill level quotient with the competitor's skill level quotient and generates a handicap. The game server may also group the player's and competitor's skill level quotient into one or more different skill classes and compare the differences between the two; thus generating a handicap. The player and the competitor then wager tokens on their successful outcome, which are held in escrow on the game server. Upon a successful outcome, the winning party is paid the pay out odds generated amount of tokens which was held in escrow by the central game server. The players and competitors are only able to play the games of skill while connected to the central game server. This provides for a total record of all game playing statistics and maintains total transparency of statistics to all players.

Suitable connection devices include one or more of a personal computer, a dedicated video game console, a cellular communication device, for example, an analog or digital cellular phone, PDA, Blackberry® device, smart phone or similar devices, and any other device capable of connecting to the central game server.

Suitable central game servers include any device known in the art used to host games on the World Wide Web. The central game server may be configured in such a way to allow for a multitude of players to connect. The number of players allowed to connect to the central game server will depend on the types of game of skill hosted on it.

Suitable games of skill include one or more of sports, strategy, action, adventure, or role playing games of skill. Any game that the outcome is based substantially on the player's skill rather than by chance is suitable for use within this invention.

The players' game profile may include one or more statistical records. Suitable statistical records include one or more of wins, loses, total number of games played, number of games played for an individual game of skill, winning percentage, money won, money lost, time spent playing individual games of skill, total time spent playing all games of skill, total time spent playing practice games, total time played globally, average skill level quotient, highest skill level quotient obtained, lowest skill level quotient, and any other statistic that is appropriate for individual games of skill. In addition, each statistic may be related to all games of skill played on the central game server or related to each individual game of skill on the game server. Each player's game profile will be publicly available; the data may be correlated into easy to read charts. The players' complete competition history may be recorded. This will allow for a competitor to see a player's skill progression. This data may be correlated into easy to read charts, which would be similar to historical stock price research. The statistics may be updated real time to provide complete transparency to potential competitors.

A player's skill level quotient may be calculated from any combination of statistical records. When determining the skill level quotient, the central game server will take into account the game of skill being played. Therefore, specific algorithms for generating the players' skill level quotient are with the knowledge of one skilled in the art.

A player's skill level quotient may move up or down depending on their performance and usage of the site. When a player selects their game of skill, they will be prompted to select an opponent based upon their own unique set of criterion. For example, the player may want to challenge a competitor having an equal skill level quotient, or alternatively the player may wish to challenge either a competitor of lesser or greater skill quotient. Players may select a set of criteria to search for a competitor. For example, a player may select a preferred handicap, e.g. 3 to 1, and the central game server will automatically match the player with a competitor seeking the handicap of 1 to 3. Players may also have the ability to set their own handicap between themselves. This will allow for a player to challenge an opponent whom they believe is over or under ranked. For example, a player may be over ranked because he had a high winning percentage due to repeatedly beating competitors with a low skill level.

The skill level quotient may be correlated into a skill class level. This skill class level will be determined by the average global skill level of all players of a selected game of skill. The game server will determine the ranking all of all players for the individual game of skill and then will break that list into a predetermined number of class levels. The number of class levels will be related to the total number of players ranked for an individual game of skill. For, example, if there were 1000 ranked players for an individual game of skill the game server may determine that there are 5 distinct skill class levels (i.e., players ranked 1-200 would be in skill class level 1 and correspondingly players ranked 800-1000 would be in skill class level 5).

The difference in skill level quotients will dictate the odds generated between the competitors and ultimately the pay out levels for the winning party. This dynamic ranking and odds generating method serves as a check and balance which promotes fairness between two parties. For example, a first player may have a skill level quotient of 5 and a competitor may have a skill level quotient of 10. In this scenario, the pay out odds would be 1 to 2, wherein the more experienced competitor would have to “risk” more in order to make money upon a successful outcome.

Tokens, as used herein, are online currency units which are generated by depositing money into the players account. The player may deposit money from any money transfer source known in the art. For example, the players may fund their account by wire transfer, credit card, personal check, certified check, online money transfer services, such as paypal, and bank transfers.

In order to maintain the fairness of the method, the games of skill will not be able to be played when the player is not connected to the game server. A player may be allowed to play a specified number of “free” practice games in order to become acquainted with the rules and structure of the game of skill. A free game would be any time a player would participate in a game with a competitor wherein no money is wagered on the game. By only allowing the players to play the game while connected, the central game server can accurately determine the skill level quotient. Players can challenge competitors with the knowledge that the statistics and skill level quotient will accurately reflect the competitors' true skill in that particular game. Players will not have to worry that the competitors have spent hours practicing the game of skill offline; thereby increasing skill level without recording game statistics and correspondingly increase the publicly available skill quotient or skill class level.

The present method also allows for the creation of “professional” game leagues based on players' skill level quotient and skill class level. Each game of skill may have a designation that players can earn by obtaining a minimum skill level quotient. Once designated as a professional, players may qualify for a profession league games, which allow for a greater wager and subsequently, will have a greater payout potential than normal games. Professional players can be separately ranked and a world wide professional ranking may be generated. By designating higher skill level players as “professional”, different events and games can be marketed to the correct audience and an incentive to less skilled players is created to improve their skill level quotient.

The player's skill level quotient may be made by determining the total number of players registered for the individual game of skill. The individual players winning percentage is determined by calculating the number of successful outcomes out of the total number of games played. The winning percentages are compared to all other players and the players are ranked from lowest winning percentage to highest winning percentage. Once the players' rank is determined, the total ranked players are grouped into 5 distinct skill level classes. For example, players with a winning percentage of 0.200 or less would be in group 5. A player with a winning percentage of 0.900 would be ranked in group 1. Upon a selection of a competitor, the game server would compare the player's skill level class to the competitor's skill level class and a handicap between 1:5 to 5:1 may be generated.

Since the players and competitors cannot play the games of skill while not connected the game server, the players' and competitors' true skill level quotient can be fairly evaluated. Thus, players may choose to challenge a more skilled competitor and have the opportunity to have a higher token payout upon a successful outcome. Conversely, players may choose to challenge a less skilled player and the player would have to wager more tokens in order to have a positive payout.

Using this method for the determination of the player's skill level quotient, professional status would be for all players grouped in the skill class level 1. These players would have the opportunity to compete in games which higher numbers of tokens could be wagered on the successful outcome. In addition, the players would qualify to compete in the tournaments and any other game of skill which requires a “professional” designation.

Further, players with the designation of professional would be eligible for sponsorship and would have the ability to alter their online appearance to include sponsors advertisements, logos, or any other depiction of the sponsor's brand. Once connected to the game server, professional players would have the option to run a program designed to customize the player's online character. For example, a professional player who competed in a golf game could upload an image file that renders a new visor for the computer generated player to wear while competing in tournaments or any type of game of skill.

Also provided is an apparatus for connecting to the central game server. The apparatus provides a means for connecting to the central game server via a communications network. The apparatus would include a network access device and a means for storage of a player's game profile. The apparatus would serve as a means for storing all local usage statistics and would interact with the central game server to provide game profile statistics and the central game server would subsequently compute the skill level quotient and skill class level. The apparatus may be constantly connected to the central game server, even if the player is not actively playing. This allows the apparatus to continually update a player's skill level quotient and skill class level as it fluctuates with the change in global rankings.

The present invention provides a method of handicapping two players competing in a game of skill. The Player 1 connects to a Central Game Server 3 via the World Wide Web 2. The Central Game Server 3, includes one or more of Page Server 4, Game Server 5, Ranking Server 6, CGI Server 7, Email Server 8, Database Engine Server 9, Global Rankings Server 10, and Credit Card Database Server 11. The Central Game Server may further include any server necessary to allow a multitude of players to connect and compete in any game of skill.

Once connected to the Central Game Server 3, the Player 1, has one or more of the following menus to access including Account Information 13, Credit Card Information 14, Game Specific Statistics 15, Global Game Statistics 16, Game Specific Rankings 17, Global Rankings 18, Scheduled Competitions 19, Past Competition Records 20, Email 21, and a Friend List 22. In addition, any other menu which is specific to a game of skill or the online community may be included.

When the Player 1 is connected to the Central Game Server 3, the Player 1 logs in to the Central Game Server 23. After login, the Central Game Server 3, retrieves and loads the Players game profile 24. The Player 1 then selects a game of skill to compete in 25. The Central Game Server 3, calculates the player's 1 Skill Quotient for that particular game of skill 26. After the Central Game Server 3, calculates the Skill Level Quotient for Player 26, the Central Game Server 3, then calculates the Global Real Time Rankings for the Game of Skill selected 27. Once the Global Real Time Rankings are generated, the Central Game Server 3, designates the Global Skill Class Level Structure 28. The overall structure of the Skill Class Level designations depends on the total number of ranked players. For example, the greater the number of globally ranked players, the greater the number of distinct skill class levels. After the Global Real-Time Skill Class Level Structure is determined, the Central Game Server 3 designates Player's 1 Skill Class Level for the game of skill selected 29.

With this Skill Class Level designated, Player 1 can challenge a second Player 30 in the selected game of skill 49. The Central Game Server 3 compares the Skill Class Level of Player 1 and second Player 30. The Central Game Server 3 then generates a handicap 36 between Player 1 and second Player 30 for the selected game of skill.

Player 1 and second Player 30, wager money on a successful outcome based on the generated handicap 37, 38. The money wagered is deposited into a third account on the Central Game Server 3 pending the outcome of the game of skill 39. The Central Game Server 3, may then deduct a variable fee from the individual players wagers 40. The Central Game Server 3 may also deduct a variable fee from the total money wagered. For example, when a multitude of players compete in a tournament type game, the Central Game Server 3 may deduct a fee from the total amount of money deposited.

Player 1 and second Player 30 compete in a game of skill 41 and an outcome is determined 42. The Central Game Server 3 pays out the money deposited into a third account according to the designated handicap 43. This payment is debited from the unsuccessful player and debited to the successful player 44, 45 minus the variable fee. The Central Game Server 3 updates Player 1 and second Players 30 game profile to reflect the outcome of the game of skill 46, 47. The Central Game Server 3 then updates the Global Real Time Rankings for the game of skill selected 48.

Also provided by the present invention is an apparatus for verifying a player of a game of skill. The apparatus is in the form of an input controller that allows a user to control the game of skill being played. The input controller may be in the form of a video game controller, a mouse, a driving wheel or any other device that allows a user to input commands to a computing device. The input device includes one or more joysticks, one or more input buttons, one or more biometric sensors, and a wire connecting the input device to a central gaming machine.

When the user operates the input device, the user must maintain contact with the biometric sensor. The biometric sensor may be a fingerprint scanner, a bioimpedence sensor or any other sensor which is capable of verify the identity of the user.

The present invention enables a new and exciting way of allowing players to make use of electronic funds accounts, automate the generation of certain required forms, and to verify their age in a manner that is fast, inconspicuous, can be implemented to insure privacy, and provides very high assurance to competitors or other gaming systems using the system.

A player identification database is created, where an entry corresponding to a player comprises at least one record, and the record has fields comprising one or more of a game profile, usage statistics, credit card information, global ranking statistics, image files, or any personal data. A player and a gaming company may use the present invention in several steps. The first is to create an entry in the player identification database, which associates the biometric data to the game profile. The player then goes and uses the input device. While using the input device, the input device will randomly and continuously scan and verify that the user competing is the user whose game profile is active. The player logins to the game system and selects a game of skill to compete in. The player selects a competitor, which has also been verified and begins competing in a game of skill. The players may wager money on the outcome of the game of skill based on the generated handicap.

An input device includes any type of game device. Suitable game devices include any electronic or electromechanical, mechanical, or table (manual) game device usably by a player for any function in a gaming environment. Game device further includes the use of a remote computer, typically a home PC, when used for gambling or gaming purposes by being operably coupled through a network to at least one central server, and where being so coupled over a network allows the home PC to be used for any type of gambling, for wager money of the outcomes of games of skill. Included in the definition of game device are any games of skill or any game that combines skill where a player may win award credits, game credits (changeable to monetary equivalents), or cash prizes. An example of this type of game could be any of the driving skill games currently popular in arcades.

In addition to the one or more biometric sensors, the input device may further include one or more of a central processor, associated memory, input/output interfaces, peripheral interfaces to the video display, control buttons and lever, monetary input devices, firmware, software needed to implement the full functionality of the game, an LCD display to display statistics, profile or rankings, a flash memory slot or any other type of swappable memory drive used for inputting data, and a means for swiping a credit/debit card and storing the associated data.

The input device may include a means for connecting to a computing device and an embedded system for maintaining and updating a database. The configuration would allow for the local storage of the biometric data and the users game profile. The device may have sufficient a sufficient means for processing and storage of a plurality of users game profiles.

Also provided in the present invention is an input controller (FIG. 6) that includes one or more biometric sensors 49, one or more input buttons 50, one or more a hot swappable memory card slots 51 e.g. flash memory, a credit card reader 53, one or more joysticks 52, a LCD display 56, one or more means for transporting data to a computing device, e.g., a wire 54, and one or more means for interfacing with the computing device, e.g., USB or Firewire.

While the present invention has been described in terms of its specific embodiments, certain modifications and equivalents will be apparent to those skilled in the art and are included within the scope of the present invention.

What is claimed is:

1. A method for distributing software, the method comprising:
a software user creating a user profile which includes one or more types of biometric data;
providing the biometric data to a software distributor;
obtaining the software; and
utilizing the software on the user's computer having a biometric sensing device that senses or measures a biometric parameter of the user useful for creating biometric data, wherein utilizing the software causes the activation of a verification program or function that compares the sensed or measured biometric data to the biometric data in the user profile.

2. The method of claim 1, wherein the sensing or measuring is performed on a random basis.

3. The method of claim 1, wherein the sensing or measuring is performed on a random and continuous basis.

4. The method of claim 1, wherein the verification program includes an algorithm that sets a rate of verification.

5. The method of claim 1, wherein the verification program includes a frequency of scanning of the biometric parameter.

6. The method of claim 5, wherein the frequency of scanning can be varied based on one or more previous measurements of the biometric parameter and the verification of the correct user or incorrect user.

7. The method of claim 6, wherein a verification of an authorized user results in a decrease in the scanning frequency.

8. The method of claim 6, wherein a verification of an unauthorized user results in an increase in the scanning frequency.

9. The method of claim 1, wherein the biometric sensing or measuring device comprises an input device capable of scanning biometrics of the user.

10. The method of claim 9, wherein the input device comprises a computer mouse having fingerprint scanning capabilities.

11. The method of claim 1, wherein the software locks out the user if the comparison of the sensed or measured biometric data to the biometric data in the user profile indicates the user is not authorized to use the software.

12. The method of claim 1, wherein the user provides the user biometric data and/or obtains the software by connecting the distribution site by connecting via the internet

13. The method of claim 1, wherein providing biometric data further comprises providing a user profile comprising one or more types of personal information of the user.

14. The method of claim 1, wherein the biometric data is incorporated directly or indirectly into the software program being obtained by the user.

15. The method of claim 14, wherein the biometric data is stored on a central server.

16. The method of claim 14, wherein the biometric data is stored on a local computer.

17. The method of claim 1, wherein obtaining the software comprises downloading the software over the internet.

18. The method of claim 1, wherein the user has the ability to use the software on any computer having the software by using an input device that allows for the comparison of the user's biometric data to the biometric data obtained for the user's profile.

19. An apparatus for verifying the identity of a player competing in a game of skill over the internet, the apparatus comprising an input controller comprising at least one biometric sensor, wherein the biometric sensor scans continuously or semi-continuously and randomly throughout game play and verifies that the biometric scan matches a biometric scan which is associated with the player, at least one directional controller, one or more input buttons and at least one means for connecting to a computer based device.
